(19) United States
(12) Patent Application Publication
(10) Pub. No.: US 2015/0012545 A1
(43) Pub. Date: Jan. 8, 2015

(54) TOOL TO QUANTIFY INFLUENCE OF INDIVIDUAL USERS

(71) Applicant: Internet Brands, Inc., El Segundo, CA (US)

(72) Inventor: Noam Katz, Simi Valley, CA (US)

(73) Assignee: INTERNET BRANDS, INC., El Segundo, CA (US)

(21) Appl. No.: 14/325,293

(22) Filed: Jul. 7, 2014

Related U.S. Application Data
(60) Provisional application No. 61/843,854, filed on Jul. 8, 2013.

(51) Int. Cl. G06F 17/30

(52) U.S. Cl. CPC G06F 17/30595
USPC 707/748

(57) ABSTRACT

A method and system for scoring individuals within a community, for instance an online forum, based on the individual's contribution to the community in terms of not only quantity but quality. The score is determined by analyzing the activity of the individual, including replies other individuals have made to the individual's activity, and may weigh each reply based on a score of the individual making said reply. Analysis may also consider factors such as number of topics or comments, number of views or subscriptions by other individuals, and/or duration of time since the individual joined the community, among other possibilities. Once all factors are determined, the values of the factors are multiplied by associated weights, then summed for a score. The score may be standardized on a fixed scale as a final operation.

### CROSS-REFERENCE TO RELATED APPLICATIONS

This application claims the benefit of U.S. Provisional Application No. 61/843,854, filed on Jul. 8, 2013 in the U.S. Patent and Trademark Office. All disclosures of said provisional application are incorporated herein by reference.

### BACKGROUND OF THE INVENTION

1. Field of the Invention

The present invention relates to a method and system which scores individuals based on their participation in a community, for instance an online forum. In particular, although not exclusively, the invention calculates a score based on activity that encourages participation of other individuals and therefore creates a more active community.

2. Description of the Related Art

In an online community, such as a forum, a high quality and quantity of interaction is of benefit to the community, encouraging new users (that is, participating individuals) to join the community and existing users to remain. To encourage this interaction, it may be desirable to score users based on their contributions to this interaction. A score may influence a user's social prestige in the community, and may also grant other benefits, whether supplied via the forum software or otherwise.

Scoring is frequently automated based on an algorithm. Most such algorithms take into account the number of “posts” or “comments” that a user creates, a comment being a single message made public to the community or a subset thereof. Sometimes, such algorithms give extra weight to comments that start a new “topic”—a “topic” being a new subject of conversation—as opposed to a comment that is in reply to an existing topic.

However, both such factors measure only the frequency of the user's activity, not its quality. In other words, algorithms that focus on these factors will score users based solely on the amount of noise they create. A user can exploit such algorithms for a higher score by creating large numbers of comments with little or no benefit to the community, while another user who spends time creating thoughtful and beneficial comments will fall behind, even though the latter will bring more benefit to the community.

Therefore, a system that calculates the true value individuals bring to an online community, in terms of both quantity and quality of their comments, is desired.

### SUMMARY OF THE INVENTION

While not limited thereto, an embodiment of the present invention is directed to a method whereby a community scores the activity of an individual or user by determining a value for one or more factors for the individual through analysis of the activity of the individual, and calculating a sum of the values of the one or more factors.

According to an aspect of the invention, the community may be an online forum or other online community.

According to an aspect of the invention, the one or more factors may include a “reply factor”; for instance, a number of replies to comments that the individual has created, or a product of the number of replies an other individual has made to comments that the first individual and the score of the other individual, summed for all other individuals.

According to an aspect of the invention, the score may be standardized on a scale, for instance from 1 to 100.

According to an aspect of the invention, the scoring may analyze a specific scope of activity.

According to an aspect of the invention, the scoring method may include, before calculating the sum of the one or more factor values, multiplying each factor value by a weight value associated with the corresponding factor.

While not limited thereto, an embodiment of the present invention is directed to processing instructions for implementing one or more of the aforementioned methods using one or more processors, encoded on a non-transitory computer readable medium.

While not limited thereto, an embodiment of the present invention is directed to a system including a machine-readable memory storing a database, a transceiver in communication with the memory and further in communication with a network, and a processing unit in communication with the memory and configured to execute one or more of the aforementioned methods.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flowchart depicting a method by which activity data is stored to an activity database, according to an embodiment of the invention.

FIG. 2 is a flowchart depicting the method by which the score of an individual is calculated, according to an embodiment of the invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

1. General Terminology and the Prior Art

An online community, in particular a forum, has a plurality of participating individuals (or “users”; the terms shall be used interchangeably herein) who use the community to interact with each other. A community may require a registration process before an individual may participate, this process involving provision of a user name or ID, in most cases a password, and perhaps other information. In some communities, the community might identify an individual by IP address or computer MAC address, or by some other method; in still other communities, the user may have the option to select an identification method from two or more of the above.

Communities also exist where individuals may participate in complete anonymity. The present invention can only be accurately applied to individuals who are identified, but may be implemented in a community where such identification is optional; in such cases, those who remain anonymous will not receive a score. For the purposes of this description, an individual “joins” the community when he or she first provides identifying information. It is important to note that the identifying information need have no association with any real-world qualities of the participating individual; for instance, a user name need bear no resemblance to the corresponding individual's actual name, so long as the same individual can be expected to use it every time.

Communities may be divided into sub-communities, sub-sub-communities, and so forth. It will be recognized by those skilled in the art that, although data such as user information may be shared between these sub-communities, the invention may be implemented in a sub-set of the sub-communities in a community, and furthermore that different specific embodiments may be implemented in different sub-communities. Therefore, hereinafter the term “community” is treated as equivalent to “sub-community”.

In an online community, individuals may create comments; that is, a message of some sort that can be seen by other participating individuals, or in some cases by a subset thereof. These comments may contain text, embedded images or other media, hypertext links to other content, and/or attached files, among other options. A comment may be the start of a new “topic”—usually, a new subject for discussion—or the comment may be a reply to an existing topic; some communities allow the same comment to serve both purposes. Most communities allow replies to comments that begin a topic, although in some communities, it is also possible to reply directly to comments that did not themselves begin a topic.

Hereinafter, a comment that is the start of a new topic, and the new topic itself, are treated as equivalent. Both “replies” and “topics” are therefore categories of “comments”. Furthermore, a reply to a reply to a comment is treated as equivalent to a reply to the comment itself; this equivalence may be expanded recursively. Furthermore, a comment created by a particular individual shall be referred to as “the individual's comment”, and so forth with replies and topics.

In many communities, a series of topics will be listed and partially displayed in a central location. The topics will be displayed using a summary of some sort, such as a title sentence, or a first few sentences of the initial comment. An individual may see the details of the topic by “viewing” it, usually by selecting a link associated with the topic. Viewing a topic or comment may also display all replies to it, or just a subset thereof.

An individual may have the option of “subscribing” to a topic or other comment. When subscribed, the individual will be alerted when new activity occurs in relation to the topic or comment. In most cases, this will mean a reply, although such activity may also include editing or deletion of the topic/comment or its replying comments. The alert might come in the form of email, text messages, internal messages within the community's software, another form of communication, or some combination, depending on the embodiment and the settings that the individual may have selected.

Many communities have one or more administrators; that is, people in charge of maintaining the community. An administrator may or may not also be treated as a user, but will have control over the community not granted to most users for the purpose of maintaining the community's operation; this control may, in various embodiments, include the ability to delete comments or topics, ban users, create new sub-communities, and change the settings and appearance of the community's interface, among many other abilities. In some embodiments, moderators also exist and have a subset of the abilities of administrators. Although the term “administrator” will be used for convenience hereinafter, it will be obvious that a moderator may serve the same role in some embodiments of the invention. Also, although a single administrator is assumed herein for convenience, it will be obvious that the invention may be practiced with a plurality of administrators.

2. Data Storage of Activity

In at least some embodiments of the present invention, one or more of the above types of actions—registration, commenting (both topics and replies), viewing, and subscribing—are recorded in an activity database, to be used in calculating “factors” for associated individuals. Hereinafter, the above actions are collectively referred to as “activity” or “community activity”, with each single such action being an “act” or “community act”; additional actions by individuals in the community may also qualify as “activity”, and may likewise be recorded in the same database. One process by which this may be performed is described as follows.

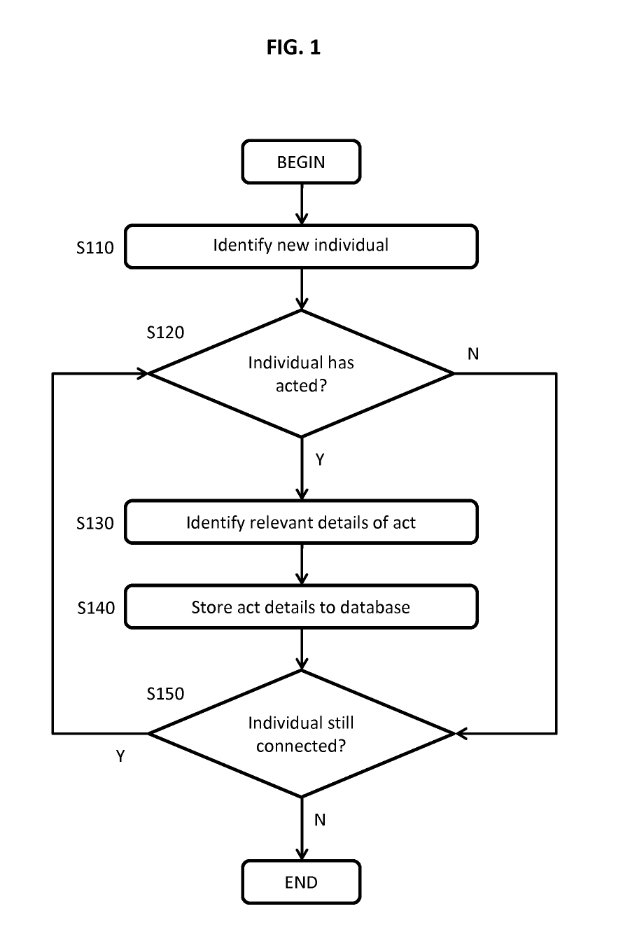

FIG. 1 is a flowchart depicting a method by which activity data is stored to an activity database, according to an embodiment of the invention.

The system receives an individual's identification at S110, for instance through a login process. In some embodiments, the identification may be automatic and performed by the system, for instance by identifying a login cookie or a known IP address.

The system then sees for the individual to conduct an act at S120. If the individual has not conducted an act, the system moves ahead to S150 to see if the individual is still connected, and if not, the method terminates. If the individual is still connected, the method returns to S120. Once the individual conducts an act, however, the system proceeds to the next operation.

In some embodiments, relevant details of the act may be determined at S130. As one example, each act may be relevant to the individual or other individuals depending on the needs of the embodiment of the scoring algorithm, described more fully below. For instance, a reply to a comment may be relevant to both the individual who made the comment and the individual who made the reply. The relevant individuals may need to be determined before the information may be stored.

At S140, the relevant details of the act are recorded in the database. In various embodiments, the recordings might note some or all of the following details: the type of action, the time and date thereof, the acting individual (and any other relevant individual), and the topic or comment acted upon.

If the individual is still connected to the system at S150, the system returns to S120 to wait for a new act and the process repeats. If the individual is not still connected, the method terminates.

3. Calculation of Individual Score

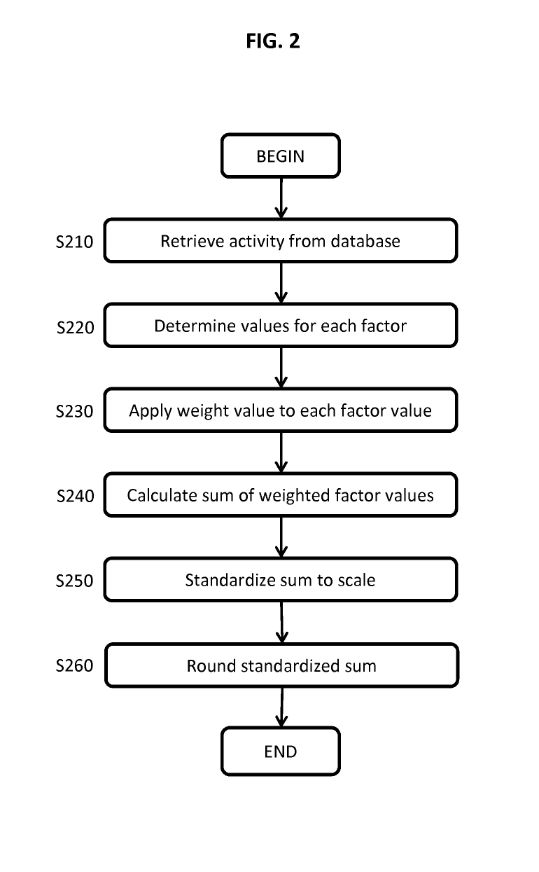

FIG. 2 is a flowchart depicting the method by which the score of an individual is calculated, according to an embodiment of the invention.

Each individual who can be identified is given a calculated score. This score may be recalculated at any regular interval or, alternatively, every time a new action relevant to the score is recorded in the activity database.

To calculate an individual's score, an algorithm first retrieves activity pertaining to each factor from the activity database at S210. The possible factors are numerous, and in some embodiments an administrator may select a certain subset of factors to be considered from a larger set.

In some embodiments, the algorithm may consider all activity from the moment an individual joined the community, while in others, only activity within a specific time frame such as the past month or the past year is considered.

Furthermore, in some embodiments, the algorithm may consider only activity relating to a specific topic; for example, a factor that would normally include all comments anywhere in the community will instead include only the topic and any replies to the topic. Such narrowing of the scope of the algorithm may occur every time the algorithm runs or only in some cases; as one example, it may be desirable to show both an overall score and a score within a topic currently being viewed.

Other narrowed scopes of the algorithm will be obvious of those of skill in the art. Furthermore, some or all such scope changes may be optional settings presented to the administrator.

A value for each factor is then determined at S220. As noted, numerous factors are possible depending on the specific embodiment, and in some embodiments an administrator may select a certain subset of factors to be considered from a larger set,

One possible factor is a total number of the individual's topics.

One possible factor is a total number of the individual's replies. In embodiments where it is possible for a reply to also be a separate topic, this factor may or may not also include replies that are topics.

One possible factor is a total number of the individual's comments. The presence of this factor in an embodiment does not preclude topics alone, replies alone, or both being separate factors in the same embodiment.

One possible factor is a total number of replies that other individuals have made in reply to the individual's topics. In embodiments where it is possible to reply directly to all comments including other replies, this factor may include replies to all of the individual's comments, or merely replies to the individual's topics. This factor may include replies by the individual currently being scored—that is, where the individual is replying to his or her own topic or other comment—although it is preferable for the purpose of the invention that such replies not be included. For the purposes of this invention, all of the above variations on this factor, or any other factor that considers one or more replies made to an individual's comments as at least a part of the determination of its value, shall be termed “reply factors”.

One possible factor is a total number of times that other individuals have viewed the individual's topics. This factor may count multiple views by the same individual separately, although it is preferable for the purpose of the invention that each individual only be counted once per topic.

One possible factor is a total number of subscriptions to the individual's topics.

One possible factor is a ratio of a total number of the individual's topics to a total number of the individual's comments. Alternatively, or in addition, one possible factor is a ratio of a total number of the individual's topics to a total number of the individual's replies.

One possible factor is a total length of time between the moment the individual joined the community and the present moment. This length may be expressed as a number of days, although other units of time may also be used. In cases where only activity within a specific topic is being considered, this factor may be unchanged, ignored, or replaced with a total length of time between the moment the topic was created and the present moment, according to the needs of the embodiment.

One possible factor, which is another reply factor, considers not only replies to the individual's comments but which other individuals are creating them. A group of individuals may try to increase each other's scores more rapidly by agreeing to reply to each other's comments; a factor of this type avoids such exploits by placing more emphasis on replies from individuals that already have high scores. One possible formula for calculating the value of such a factor may be:

$${\sum }_{i = 1}^{n} ( {s}_{i} * {r}_{i} ) \qquad ( Formula 1 )$$

where n is a number of other individuals in the community, sᵢ is the score of an other individual i, and rᵢ is the number of replies the other individual i has made to one or more comments that the individual has created. This factor may also be altered to consider only replies to an individual's topics. This factor may also be altered such that sᵢ is not the actual score of the other individual i, but the score after being adjusted through methods such as applying an upper or lower limit, standardizing on a curve, or other options. To avoid issues such as infinite loops, sᵢ may be determined based on the individual i′s score at a previous scoring.

Two possible factors apply an equivalent consideration or formula to the views and subscriptions, respectively, that the individual receives from other individuals.

In various embodiments, the individual being scored may or may not be included in the term “other individuals” for the purposes of determining the factors listed above.

In some embodiments, at S230, the algorithm may then multiply each factor by a weight value associated with that factor, resulting in a series of weighted factors. In some embodiments, these weight values may be adjustable by an administrator, to experiment or to meet the specific needs of the community.

In some embodiments, the sum of all weight values may be deliberately set to a specific number, such as 1. Maintaining this sum while adjusting the individual weights may help in comparing the effects of different sets of weight values between communities.

As an example embodiment, the factors for an individual may be a number of topics that the individual has created, with a weight value of 0.30; a number of replies to topics that the individual has created, with a weight value of 0.20; a number of subscriptions to the topics that the individual has created, with a weight value of 0.19; a number of days since the individual joined the community, with a weight value of 0.01; and a number of replies that the individual has made to topics, with a weight value of 0.30.

Some embodiments may also include factors with negative weight values. For instance, one factor may be a total number of the individual's topics that have no replies; this factor may be a sign of unhelpful or unwanted topics. As such noise is against the purpose of the community, this factor may have a negative weight value, such as −0.10, such that it will count against a high score.

Although all weight values above have been described to two decimal places and with an absolute value less than one, the invention is not limited from more precise weight values, nor to weight values with an absolute value equal to or greater than one. Furthermore, a weight value might be applied in a manner other than multiplication without departing from the scope of the invention.

Once all factors have been weighted, the weighted factors are added into a sum at S240, which the algorithm returns as the score of the individual.

In some embodiments, before returning the score, the algorithm may standardize the score against all other scores, for instance on a scale from 1 to 100, at S250. A variety of standardization methods are well known in the art, and will not be elaborated on here.

In some embodiments, before returning the score, the algorithm may round the score to the nearest whole number, at S260.

3. Benefits of the Invention

In many embodiments, the score of each individual may be seen by others viewing the community, and especially those viewing the comments of the given individual. This results in community prestige, whereby the individual's comments may be thought of as more important, more trustworthy, and/or otherwise more worth viewing. This score will also demonstrate to the individual that the individual's activity is recognized and appreciated as important to the community, increasing morale and encouraging further such participation.

Also, an administrator of the community may use a score as a simple measure of the worth of the individual to the community. For instance, when deciding whether and how to deal with a dispute between individuals, it may behoove the administrator to show preference or leniency to an individual with a high score, in the knowledge that this individual has provided greater benefit to the community in the past.

Additionally, a score above certain thresholds may designate an individual as having a higher “rank” within the community, which may convey certain benefits. As but one option, in a location where multiple topics are listed, a high-ranking individual's topics may be sorted above the topics of those of lower ranks, such that the high-ranking individual's topics are seen first by those viewing the community. This sorting may also be conducted without use of rank, simply on the basis of individual score. A high-ranking individual's topics may even be linked or made visible from a more prominent location on the community or related locations, such as a home page.

A high rank or score may in some embodiments also convey other benefits. For instance, high-ranking individuals may receive access to additional features such as exclusive sub-communities. Also, a high rank may qualify an individual for moderator or administrator duties. Additionally, achieving a high rank or score may earn digital or even physical prizes, and seeking higher scores or ranks may become an informal, or even formal, competition within the community.

Due to these benefits to users, the invention promotes an active community by surfacing users that encourage engagement. While a true quality of a user's posts is subjective to a specific community and can't be readily identified, the algorithm takes an objective approach by factoring in the behavioral reaction from other users. This approach provides a quantitative signal which is universal to all communities.

4. Other Applications of the Invention

The algorithms and other processing instructions described herein may all be encoded on a non-transitory computer readable medium, with the instructions to be implemented using one or more processors.

A processing unit may be configured to execute the algorithms and other processing instructions described herein. The processing unit may be in communication with a machine-readable memory storing the activity database; the memory may also store software or data implementing other features of the community. The memory may also be in communication with a transceiver, which in turn is in communication with a network, such as a LAN or the Internet.

Although the invention has been described at times in terms of an online forum, other applications are possible. As but one example, in an online marketplace, the individuals could be product sellers and purchasers, the topics could be products for sale, the replies could be purchases or positive reviews (or the algorithm could count both as separate factors). “Subscribing” to a product (or directly to the seller) could provide alerts of many kinds, such as a sale or an introduction of a new product. The resulting score would then help determine which sellers best drive positive commerce on the website, and these sellers might be rewarded with lower fees, or being moved to the top of applicable product searches. Other applications can also be conceived by those skilled in the art, and are within the spirit and scope of the invention.

Furthermore, although the embodiments above have been presented in the context of an online community for convenience, it is noted that the invention is not so limited, and may be implemented in any system where individuals communicate in a manner that may be recorded and analyzed for the factors described or their equivalents.

Although a few embodiments of the present invention have been shown and described, it would be appreciated by those skilled in the art that changes may be made in this embodiment without departing from the principles and spirit of the invention, the scope of which is defined in the claims and their equivalents. In particular, all or some of the above mentioned embodiments may be selectively combined with each other.

What is claimed is:

1. A method of scoring activity of an individual in a community, the method comprising:
(a) determining a value for one or more factors for the individual by analyzing the activity of the individual; and
(b) calculating a sum of the one or more factor values,
wherein the one or more factors for an individual comprise a reply factor.

2. The method of claim 1, wherein the reply factor is equal to a number of replies to comments that the individual has created.

3. The method of claim 1, wherein the reply factor is equal to
$${\sum }_{i = 1}^{n} ( {s}_{i} * {r}_{i} )$$
where n is a number of other individuals in the community,
sᵢ is the score of an other individual i,
and rᵢ is the number of replies the other individual i has made to one or more comments that the individual has created.

4. The method of claim 1, further comprising:
(c) repeating (a) and (b) for each of a plurality of individuals; and
(d) calculating a standardized score between 1 and 100 for the individual, based on all scores of the plurality of individuals.

5. The method of claim 1, wherein the one or more factors further comprise a number of the topics that the individual has created.

6. The method of claim 1, wherein the one or more factors further comprise a number of views of the topics that the individual has created.

7. The method of claim 1, wherein the one or more factors further comprise a number of subscriptions to the topics that the individual has created.

8. The method of claim 1, wherein the one or more factors further comprise a number of comments that the individual has made.

9. The method of claim 1, wherein the one or more factors further comprise a number of topics that the individual has created.

10. The method of claim 1, wherein the one or more factors further comprise a number of replies to topics that the individual has made.

11. The method of claim 1, wherein the one or more factors further comprise a ratio of a number of topics that the individual has created to a number of comments that the individual has made.

12. The method of claim 1, wherein the one or more factors further comprise a number of days since the individual joined the community.

13. The method of claim 1, wherein the one or more factors consider only activity related to a specific topic.

14. The method of claim 1, wherein the one or more factors consider only activity occurring within a specific time frame.

15. The method of claim 1, further comprising, before (b), multiplying the value of each factor by a weight value associated with that factor.

16. The method of claim 15, wherein a sum of the weight values associated with each of the one or more factors equals exactly 1.

17. The method of claim 16,
wherein the one or more factors further comprise a number of topics that the individual has created, a number of replies to topics that the individual has created, a number of subscriptions to the topics that the individual has created, a number of days since the individual joined the community, and a number of replies that the individual has made to topics,
wherein the weight value of the number of topics that the individual has created is 0.30,
wherein the weight value of the number of replies to topics that the individual has created is 0.20,
wherein the weight value of the number of subscriptions to the topics that the individual has created is 0.19,
wherein the weight value of the number of replies that the individual has made to topics is 0.30, and
wherein the weight value of the number of days since the individual joined the community is 0.01.

18. A system of scoring activity of an individual in a community, the system comprising:
a machine-readable memory storing a database;
a transceiver in communication with the memory and further in communication with a network; and
a processing unit in communication with the memory and configured to execute the method of claim 1.

19. A non-transitory computer readable medium encoded with processing instructions for implementing the method of claim 1 using one or more processors.
